(19) United States
(12) Patent Application Publication
(10) Pub. No.: US 2007/0079134 A1
(43) Pub. Date: Apr. 5, 2007

(54) SYSTEM AND METHOD FOR SECURING A COMPUTER

(76) Inventors: Gui-Hua Tang, Shenzhen (CN); Wei-Yuan Chen, Shenzhen (CN); De-Hua Dang, Shenzhen (CN); Zhao-Bin Zhang, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,963

(22) Filed: May 30, 2006

(30) Foreign Application Priority Data
Sep. 23, 2005 (CN) 200510037477.8

(51) Int. Cl. H04L 9/00

(52) U.S. Cl. 713/183

(57) ABSTRACT

A system for securing a computer is disclosed. The system includes a detecting module (101) for determining whether a portable storage device (20) connected to the computer (10) stores an key of the computer (10), a locking module (102) for locking the computer (10) if the portable storage device (20) does not store the key, and an unlocking module (103) for unlocking the computer (10) if the portable storage device (20) stores the key. A related method is also disclosed.

### FIELD OF THE INVENTION

The present invention relates to a system and method for securing a computer.

### DESCRIPTION OF RELATED ART

The comprehensive application of computers have related to users' security, especially within organizations that need to keep a high level of secrecy. The organizations may allow a user or an employee access to only one computer, and the user or the employee must secure the computer when they leave. Usually, the user or the employee can set a password to enter an operation system of the computer, so the password is an only identifier to the user or the employee.

However, setting the password is insecure. This is because the password that is set can be deciphered by unlawful means, and the user or the employee must input an entering password the same as the set password every time when entering the operation system.

Therefore, what is needed is a system and method for securing a computer, by which the user or the employee can secure the computer safely and conveniently.

### SUMMARY OF INVENTION

A system for securing a computer is provided, the system includes: a detecting module for determining whether a portable storage device connected to the computer stores an key of the computer; a locking module for locking the computer if the portable storage device does not hold the key; and an unlocking module for unlocking the computer if the portable storage device holds the key.

Further, a related method for securing a computer is also provided, the method includes the steps of: connecting a portable storage device to the computer; determining whether the portable storage device stores a key of the computer; locking the computer if the portable storage device does not hold the key; and unlocking the computer if the portable storage device holds the key.

Other advantages and novel features of the embodiments will be drawn from the following detailed description with reference to the attached drawings.

### BRIEF DESCRIPTION OF DRAWINGS

FIG. 1 is a schematic diagram of a system for securing a computer in accordance with a preferred embodiment; and

FIG. 2 is a flowchart of a preferred method for securing a computer.

### DETAILED DESCRIPTION

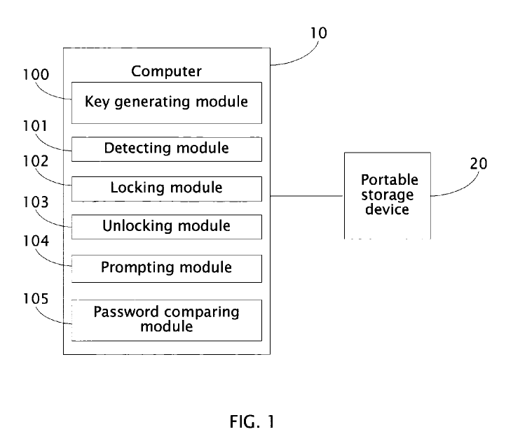

FIG. 1 is a schematic diagram of a system for securing a computer (hereinafter, “the system”) in accordance with a preferred embodiment. The system includes a computer 10 and a portable storage device 20. The computer 10 may be a personal computer or a notebook computer. Typically, the computer 10 includes a key generating module 100, a detecting module 101, a locking module 102, an unlocking module 103, a prompting module 104, and a password comparing module 105. The storage device 20 may be a U-Disk, a Compact Disc (CD), a floppy disk or any other suitable device, and is used for storing a key to secure the computer 10.

The key generating module 100 is used for generating the key according to an initialization password inputted by a user, and storing the key in the portable storage device 20, if the system is running for the first time or the portable storage device 20 does not hold the key of the computer 10. The user can input the initialization password by a keyboard or a numeral key-press device. The initialization password is stored in the key generating module 100. The key generating module 100 can use encryption arithmetic such as MD4, MD5, DES, DSA, or any other suitable encryption arithmetic to generate the key.

The detecting module 101 is used for determining whether the system is running for the first time and whether the portable storage device 20 connected to the computer 10 holds the key of the computer 10.

The locking module 102 is used for locking the computer 10 if the portable storage device 20 does not hold the key. Hereinto, the portable storage device 20 may be lost, or removed from the computer 10 by the user.

The unlocking module 103 is used for unlocking the computer 10 if the portable storage device 20 holds the key.

The prompting module 104 is used for prompting the user to generate the key of the computer 10 if the portable storage device 20 does not hold the key, and for prompting the user to input the password if there is a need to generate the key.

The password comparing module 105 is used for comparing the input password with the initialization password, and determining whether the two passwords are identical. The key generating module 100 generates the key if the two passwords are identical. Otherwise, if the two passwords are not identical, the prompting module 104 prompts the user to re-input the password.

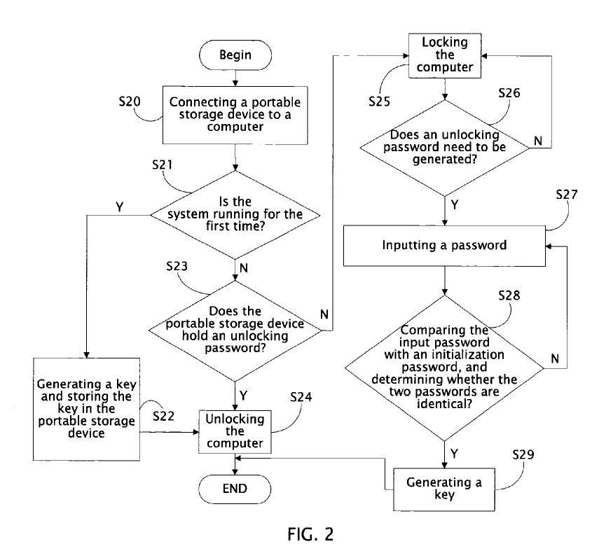

FIG. 2 is a flowchart of a preferred method for securing a computer by utilizing the system of FIG. 1. In step S20, a user connects the portable storage device 20 to the computer 10. In step S21, The detecting module 101 determines whether the system is running for the first time. If the system is running for the first time, in step S22, the key generating module 100 generates a key according to an initialization password inputted by the user, and stores the key in the portable storage device 20. Herein, the portable storage device 20 stores the key, and can unlock the computer 10 if the user is using the system for the first time. If the system is not running for the first time, in step S23, the detecting module 101 determines whether the portable storage device 20 holds the key. If the portable storage device 20 holds the key, in step S24, the unlocking module 103 unlocks the computer 10. Otherwise, if the portable storage device 20 does not hold the key, in step S25, the locking module 102 locks the computer 10.

In step S26, the prompting module 104 prompts the user to generate the key of the computer 10. If there is no need to generate the key, the procedure returns to step S25. If there is a need to generate the key, in step S27, the prompting module 104 prompts the user to input a password. In step S28, the password comparing module 105 compares the input password with the initialization password, and determines whether the two passwords are identical. If the two passwords are identical, in step S29, the key generating module 101 generates the key. Otherwise, if the two passwords are not identical, the procedure returns to step S27, and the prompting module 104 prompts the user to re-input the password.

Although the present invention has been specifically described on the basis of a preferred embodiment and preferred method, the invention is not to be construed as being limited thereto. Various changes or modifications may be made to the embodiment and method without departing from the scope and spirit of the invention.

What is claimed is:

1. A system for securing a computer, the system comprising:
a detecting module for determining whether a portable storage device connected to the computer stores a key of the computer;
a locking module for locking the computer if the portable storage device does not hold the key; and
an unlocking module for unlocking the computer if the portable storage device holds the key.

2. The system according to claim 11 further comprising:
a key generating module for generating the key according to an initialization password input by a user, and storing the key in the portable storage device.

3. The system according to claim 2, further comprising:
a prompting module for prompting the user to generate the key of the computer if the portable storage device does not hold the key, and for prompting the user to input a password if there is a need to generate the key; and
a password comparing module for comparing the input password with the initialization password, and determining whether the two passwords are identical.

4. The system according to claim 3, wherein the key generating module generates the key if the two passwords are identical.

5. The system according to claim 3, wherein the prompting module prompts the user to re-input the password if the two passwords are not identical.

6. A method for securing a computer, the method comprising the steps of:
connecting a portable storage device to the computer;
determining whether the portable storage device holds a key of the computer;
locking the computer if the portable storage device does not hold the key; and
unlocking the computer if the portable storage device holds the key.

7. The method according to claim 6, further comprising the step of:
generating the key according to an initialization password inputted by a user, and storing the key in the portable storage device.

8. The method according to claim 7, further comprising the steps of:
prompting whether to generate the key of the computer if the portable storage device does not hold the key;
prompting the user to input a password if there is a need to generate the key;
comparing the input password with the initialization password, and determining whether the two passwords are identical; and
generating the key if the two passwords are identical.

9. The method according to claim 8, further comprising the step of:
prompting the user to re-input the password if the two passwords are not identical.
